(19) United States
(12) Patent Application Publication
(10) Pub. No.: US 2016/0339852 A1
(43) Pub. Date: Nov. 24, 2016

(54) METHOD AND APPARATUS FOR SECURING A VEHICLE WIRING HARNESS

(71) Applicant: FORD GLOBAL TECHNOLOGIES, LLC, Dearborn, MI (US)

(72) Inventor: ERIC VARGAS LINAN, Metepec (MX)

(21) Appl. No.: 14/715,729

(22) Filed: May 19, 2015

(51) Int. Cl. B60R 16/02; B62D 65/02

(52) U.S. Cl. CPC B60R 16/0215; B62D 65/024

(57) ABSTRACT

A vehicle wiring harness retainer assembly and a method of securing a vehicle wiring harness are provided. The vehicle wiring harness retainer assembly may include a fastener head, a first strap, and a second strap. The fastener head may have a first opening and a second opening. The first strap may extend away from the first opening in a first direction. The second strap may extend away from the second opening in a second direction.

### TECHNICAL FIELD

The present disclosure relates to a method and an apparatus for securing a vehicle wiring harness.

### BACKGROUND

Tie straps are used in many applications to secure objects of varying dimensions. Objects such as wires may be bundled together by looping a tie strap about the wires and securing the tie strap to a mating structure. A retainer clip may be included to secure the bundled wires to the mating structure. A person attempting to install the bundled wires with the retainer clip into the mating structure may find it difficult to align the retainer clip with the mating structure due to changes in positioning of the tie strap along the bundled wires, particularly with bundles having multiple retainer clips with different orientations. Larger diameter wire bundles may be more difficult to manipulate the retainer clip during installation.

### SUMMARY

In at least one embodiment, a method of securing a vehicle wiring harness includes securing a fastener head having first and second openings and first and second integrally formed straps at a selected position along the wiring harness. The fastener head may be secured by inserting the first strap through the first opening and tightening the first strap. The fastener clip may be positioned on the second strap. The second strap may be wrapped concentrically around the first strap and through the second opening such that the fastener clip is movable along the second strap.

A method of securing a vehicle wiring harness may include positioning a fastener clip on a second strap integrally formed with a fastener head and concentrically positioned around a first strap integrally formed with the fastener head. The first strap may be spaced from the second strap. The first strap may be wrapped about a wiring harness along a length of the wiring harness and secured within the fastener head to fix the fastener head relative to the wiring harness.

In at least one embodiment, a vehicle wiring harness retainer assembly includes a fastener head, a first strap, and a second strap. The fastener head may have a first opening extending along a first axis and a first locking mechanism disposed within the first opening. The fastener head may have a second opening extending along a second axis and a second locking mechanism disposed within the second opening. The first strap may extend away from the first opening in a first direction. The second strap may extend away from the second opening in a second direction.

### BRIEF DESCRIPTION OF THE DRAWINGS

FIG. 1 is a perspective view of a vehicle wiring harness retainer assembly.

FIG. 2 is a perspective view of a portion of a vehicle wiring harness retainer assembly.

FIG. 3 is a partial sectional view of the vehicle wiring harness retainer assembly of FIG. 2.

FIG. 4 is a partial sectional view of the vehicle wiring harness retainer assembly of FIG. 3.

FIG. 5 is a partial sectional view of the vehicle wiring harness retainer assembly of FIG. 3.

FIG. 6 is a partial sectional view of the vehicle wiring harness retainer assembly secured to a vehicle wiring harness and installed in a complementary vehicle structure.

FIG. 7 is a partial sectional view of the second strap received between the first flange and the second flange of the first strap.

FIG. 8 is a flow chart of a method of securing a vehicle wiring harness.

### DETAILED DESCRIPTION

As required, detailed embodiments are disclosed herein; however, it is to be understood that the disclosed embodiments are merely representative of the claimed subject matter, which may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the teachings of the disclosure.

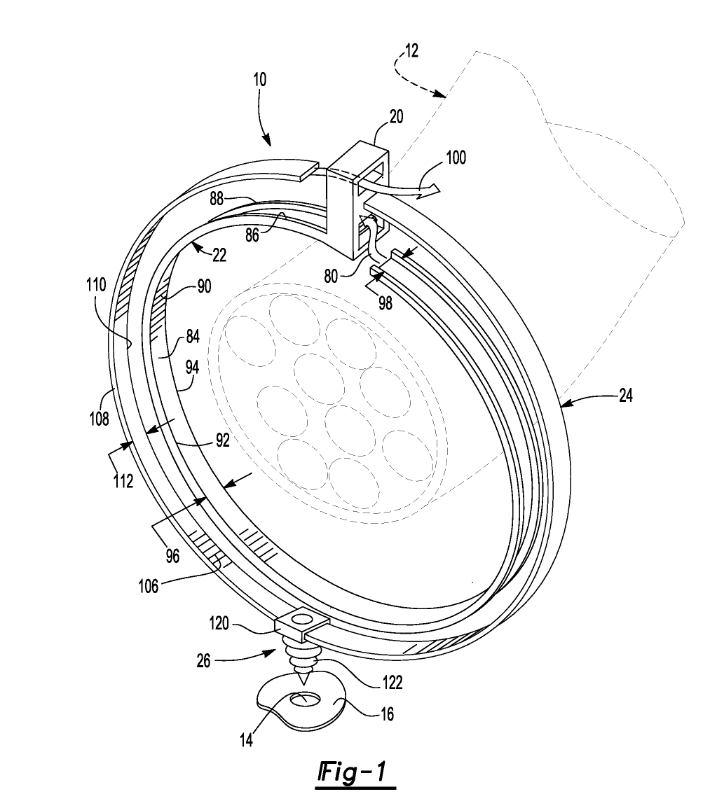

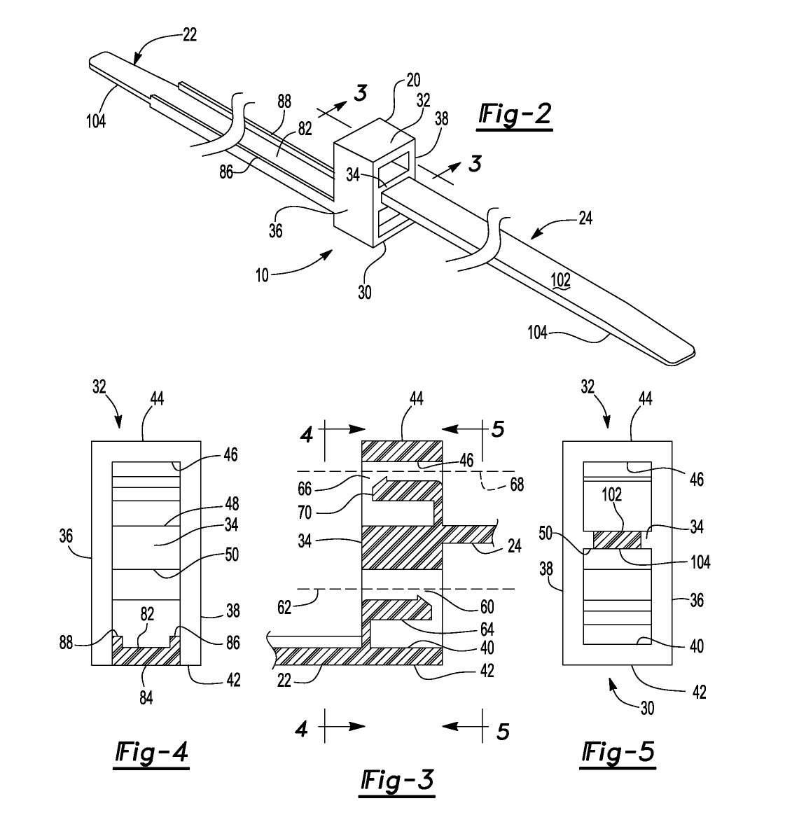

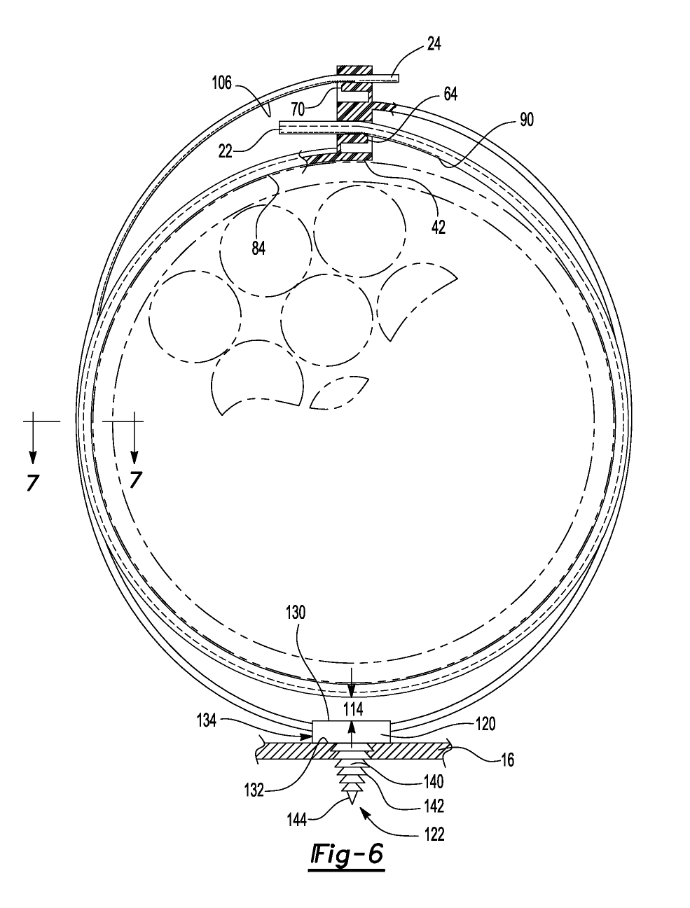

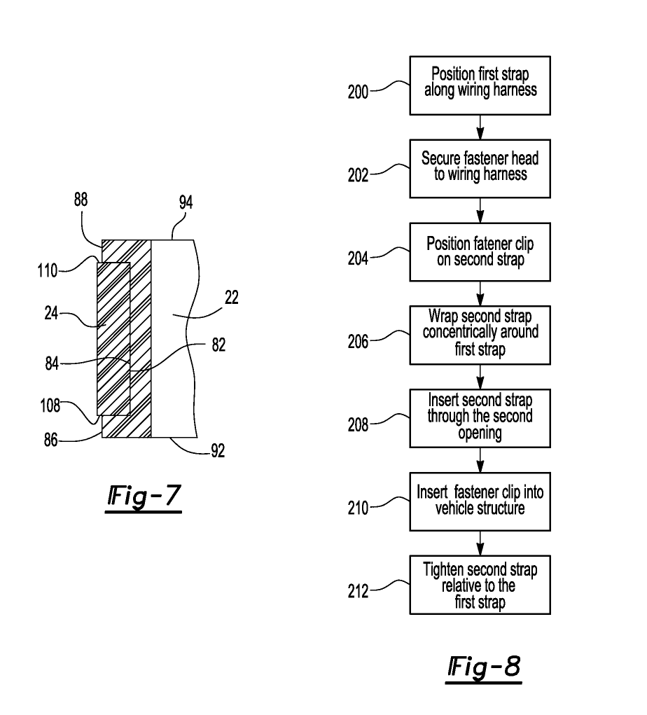

Referring to FIGS. 1-7, an exemplary vehicle wiring harness retainer assembly 10 is shown. The vehicle wiring harness retainer assembly 10 may be provided to secure a component or a plurality of components such as electrical wires or a vehicle wiring harness 12 to a wiring harness mounting point 14 defined within a complementary vehicle structure 16. The vehicle wiring harness retainer assembly 10 may include a fastener head 20, a first strap 22, a second strap 24, and a fastener clip 26.

The fastener head 20 may include a first wall 30, a second wall 32, an intermediate wall 34, a first side wall 36, and a second sidewall 38. The first wall 30 may have an upper surface 40 and a lower surface 42 that may be disposed opposite the upper surface 40. The first wall 30 may be spaced apart from and disposed opposite the second wall 32. The lower surface 42 may be configured to engage an exterior surface of the vehicle wiring harness 12 while the fastener head 20 is secured to the vehicle wiring harness 12. In at least one embodiment, the lower surface 42 may be provided with a grip feature that may be configured to restrict relative movement between the fastener head 20 and the vehicle wiring harness 12 while the fastener head 20 is secured to the vehicle wiring harness 12. The second wall 32 may have an upper surface 44 and a lower surface 46 that may be disposed opposite the upper surface 44. The second wall 32 may be completely spaced apart from an exterior surface of the vehicle wiring harness 12.

The intermediate wall 34 may be spaced apart from both the first wall 30 and the second wall 32. The intermediate wall 34 may be disposed between the first wall 30 and the second wall 32. The intermediate wall 34 may have an upper surface 48 and a lower surface 50 that may be disposed opposite the upper surface 48.

The first sidewall 36 and the second sidewall 38 may be spaced apart from each other and may extend from the first wall 30 to the second wall 32. The first sidewall 36 and the second sidewall 38 may be disposed substantially perpendicular with respect to the first wall 30 and/or the second wall 32. The first wall 30, the second wall 32, the intermediate wall 34, the first sidewall 36, and the second sidewall 38 may be integrally formed or joined together to define the fastener head 20.

The first wall 30, the intermediate wall 34, the first sidewall 36, and the second sidewall may define a first opening 60. The first opening 60 may be sized to receive the first strap 22. The first opening 60 may extend along a first axis 62. A first locking mechanism 64 may be disposed within the first opening 60. The first opening 60 and the first locking mechanism 64 may be configured to unidirectionally secure the first strap 22 within the first opening 60 secure the vehicle wiring harness 12 with the first strap 22. The first strap 22 may be unidirectionally secured within the first opening 60 such that the first strap 22 may be inserted into the first opening 60 but may be restricted from being removed from the first opening 60 in a direction opposite the insertion direction.

The second wall 32, the intermediate wall 34, the first sidewall 36, and the second sidewall 38 may define a second opening 66. The second opening 66 may be sized to receive the second strap 24. The second opening 66 may extend along a second axis 68. A second locking mechanism 70 may be disposed within the second opening 66. The second opening 66 and the second locking mechanism 70 may be configured to unidirectionally secure the second strap 24 within the second opening 66. The second strap 24 may be unidirectionally secured within the second opening 66 such that the second strap 24 may be inserted into the second opening 66 but may be restricted from being removed from the second opening 66 in a direction opposite the insertion direction.

The first strap 22 may be integrally formed with the first wall 30 of the fastener head 20. The first strap 22 may extend away from the first opening 60 and a first direction 80. At least a portion of the first strap 22 proximate the first opening 60 may be disposed substantially parallel to the first axis 62. The first strap 22 may have a first surface 82, a second surface 84, a first flange 86, and a second flange 88. The second surface 84 may be disposed opposite the first surface 82. At least a portion of the first surface 82 may be substantially coplanar with the upper surface 40. At least a portion of the second surface 84 may be substantially coplanar with the lower surface 42. The second surface 84 may be configured to engage an exterior surface of the vehicle wiring harness 12.

At least one of the first surface 82 and the second surface 84 may be provided with a series of ridges 90 that may be disposed between a first edge 92 and a second edge 94. The series of ridges 90 may have a width less than a first width 96 defined by the first edge 92 and the second edge 94. In at least one embodiment, the series of ridges 90 may be configured as a gripping feature that may aid in restricting relative movement between the vehicle wiring harness 12 and the first strap 22.

A ridge of the series of ridges 90 may be configured to engage the first locking mechanism 64. The first locking mechanism 64 may be configured as a pawl that may cooperate with a ridge of the series of ridges 90 to unidirectionally secure the first strap 22 within the first opening 60. In at least one embodiment, the first locking mechanism 64 may be integrally formed with the first strap 22 and may extend from the first surface 82 toward the intermediate wall 34. The first strap 22 may be configured to be positioned around the vehicle wiring harness 12 and secured within the first opening 60.

The first flange 86 may be spaced apart from the second flange 88. The first flange 86 and the second flange 88 may define a width 98 at least as wide as the second strap 24. The first flange 86 may be disposed proximate the first edge 92 and the second flange 88 may be disposed proximate the second edge 94. The first and second flanges 86, 88 may extend away from the first surface 82. The first and second flanges 86, 88 may define a height substantially similar to the thickness of the second strap 24. In at least one embodiment, the first and second flanges 86, 88 may extend from the first surface 82 to the second surface 84.

The second strap 24 may be spaced apart from the second wall 32. The second strap 24 may be integrally formed with the intermediate wall 34 of the fastener head 20. The second strap 24 may extend away from the second opening 66 in a second direction 100. The first direction 80 may be different than the second direction 100. In at least one embodiment, the first direction 80 may be a direction opposite the second direction 100. At least a portion of the second strap 24 proximate the second opening 66 may be disposed substantially parallel to the second axis 68. The second strap 24 may have a first surface 102 and a second surface 104. The second surface 104 may be disposed opposite the first surface 102. At least a portion of the first surface 102 may be substantially coplanar with the upper surface 48. At least a portion of the second surface 104 may be substantially coplanar with the lower surface 50.

At least one of the first surface 102 and the second surface 104 may be provided with a second series of ridges 106 that may be disposed between a first edge 108 and a second edge 110. The second series of ridges 106 may have a width less than a second width 112 defined by the first edge 108 and the second edge 110. A ridge of the second series of ridges 106 may be configured to engage the second locking mechanism 70. The second locking mechanism 70 may be configured as a pawl that may cooperate with a ridge of the second series of ridges 106 to unidirectionally secure the second strap 24 within the second opening 66. In at least one embodiment, the second locking mechanism 70 may be integrally formed with the second strap 24 and may extend from the first surface 102 towards the second wall 32.

The second strap 24 may be configured to wrap around the first strap 22 and secured within the second opening 66. The second strap 24 may be generally concentrically positionable relative to the first strap 22. The first and second straps 22, 24 may be spaced apart at the fastener head 20 and may provide a clearance gap 114 relative to one another that may permit movement of the fastener clip 26 along second strap 24 relative to the first strap 22.

The second width 112 may be less than the first width 96 such that at least a portion of the second strap 24 may be received within or between the first flange 86 and the second flange 88. The first flange 86 and the second flange 88 may be arranged such that the second strap 24 may be restricted from movement along or relative to a longitudinal axis of the vehicle wiring harness 12.

The fastener clip 26 may be positioned on the second strap 24 prior to tightening the second strap 24. The fastener clip 26 may include a first portion 120 and a second portion 122. The first portion 120 may include a top surface 130, a bottom surface 132, and an opening 134. The top surface 130 may be a generally planar surface and may be disposed substantially parallel to the complementary vehicle structure 16. The top surface 130 may be spaced apart from the bottom surface 132. The opening 134 may extend between the top surface 130 and the bottom surface 132. The opening 134 may be configured to receive the second strap 24 and the fastener clip 26 may be slid along the second strap 24 to align the fastener clip 26 with an opening of the complementary vehicle structure 16. The vehicle wiring harness 12 and the first surface 82 of the first strap 22 may be spaced apart from the top surface 130 of the fastener clip 26 to provide a second clearance gap 136.

The second portion 122 may be configured as a mounting stud to secure the fastener clip 26 to a vehicle wiring harness mounting point 14 defined in the complementary vehicle structure 16. The second portion 122 may include a body 140, a plurality of generally flexible members or branches 142, and a pilot end 144. The plurality of branches 142 extending outwardly from the body 140. The plurality of branches 142 may be spaced from one another along the body 140. In at least one embodiment, the plurality of branches 142 may be tapered towards the bottom surface 132. The plurality of branches 142 extending from the body 140 may be commonly referred to as a fir tree mounting stud or a Christmas tree mounting stud.

The pilot end 144 may be disposed opposite the top surface 130. The pilot end 144 may be configured to assist in directing the fastener clip 26 into the wiring harness mounting point 14. The wiring harness mounting point 14 may be configured as a hole or an opening in the complementary vehicle structure 16. At least one branch of the plurality of branches 142 may be configured to engage the sides of the wiring harness mounting point 14 to retain the fastener clip 26 in the complementary vehicle structure 16. The plurality of branches 142 may be configured to resist movement of the fastener clip 26 and ultimately the vehicle wire harness retainer assembly 10 away from the complementary vehicle structure 16.

Referring to FIG. 8 an illustrative method of securing a vehicle wiring harness is shown. At block 200, the first strap 22 may be positioned along a length of the vehicle wiring harness 12 relative to the wiring harness mounting point 14 and the complementary vehicle structure 16. At block 202, the fastener head 20 may be secured to the vehicle wiring harness 12. The first strap 22 may be wrapped about the vehicle wiring harness 12 and inserted through the first opening 60 and tightened. The tensioning or tightening of the first strap 22 may securely engage the second surface 84 of the first strap 22 with the exterior surface of the vehicle wiring harness 12. The fastener head 20 may be securely fixed relative to the vehicle wiring harness 12.

At block 204, the fastener clip 26 may be positioned on the second strap 24. In at least one embodiment, the fastener clip 26 may be positioned on the second strap prior to the first strap 22 being positioned along a length of the vehicle wiring harness 12 at block 200. The first portion 120 of the fastener clip 26 may be slidably engaged with the second strap 24. The fastener clip 26 may be slid along the second strap 24 to align the fastener clip 26 with the wiring harness mounting point 14 in the complementary vehicle structure 16.

At block 206, the second strap 24 may be wrapped concentrically around the first strap 22 and the vehicle wiring harness 12. The second strap 24 may be received between the first flange 86 and the second flange 88 of the first strap 22.

At block 208, at least a portion of the second strap 24 may be inserted through the second opening 66 of the fastener head 20. The second strap 24 may be inserted through the second opening 66 such that the fastener clip 26 is movable along the second strap 24. At least a portion of the first surface 82 of the first strap 22 may be spaced apart from the second surface 104 of the second strap 24 proximate the fastener clip 26. In at least one embodiment, the first surface 82 of the first strap 22 may be spaced apart from the top surface 130 of the fastener clip 26.

At block 210 the fastener clip 26 may be inserted into an opening defined by the wiring harness mounting point 14 of the complementary vehicle structure 16. The second portion 122 of the fastener clip 26 may secure the fastener clip 26 to the wiring harness mounting point 14 of the complementary vehicle structure 16.

At block 212, the second strap 24 may be tightened relative to the first strap 22. The second strap 24 may be tensioned or tightened within the second opening 66 to connect the second strap to the fastener head 20 and to secure the vehicle wiring harness 12 to the complementary vehicle structure 16.

While representative embodiments are described above, it is not intended that these embodiments describe all possible forms of the claimed subject matter. The words used in the specification are words of description rather than limitation, and it is understood that various changes may be made without departing from the spirit and scope of the disclosure. Additionally, the features of various implementing embodiments may be combined to form further embodiments that may not be explicitly illustrated or described.

What is claimed is:

1. A method, comprising:
securing a fastener head having first and second openings and first and second integrally formed straps at a selected position along a wiring harness by inserting the first strap through the first opening and tightening the first strap;
positioning a fastener clip on the second strap; and
wrapping the second strap concentrically around the first strap and through the second opening such that the fastener clip is movable along the second strap.

2. The method of claim 1 further comprising:
inserting the fastener clip into an opening of a complementary vehicle structure; and
tightening the second strap within the second opening to secure the wiring harness to the complementary vehicle structure.

3. The method of claim 2 wherein the first strap extends away from the first opening in a first direction and the second strap extends away from the second opening in a second direction.

4. The method of claim 3 wherein the first direction is different than the second direction.

5. The method of claim 3 wherein the fastener clip has a first end slidably engaged with the second strap and a second end configured to secure the fastener clip into the opening of the complementary vehicle structure.

6. The method of claim 5 further comprising positioning the first strap along the wiring harness relative to the complementary vehicle structure.

7. The method of claim 6 wherein at least a portion of the first strap is spaced apart from the second strap proximate the fastener clip.

8. The method of claim 1 further comprising:
sliding the fastener clip along the second strap to align with a complementary vehicle structure;
securing the fastener clip to the complementary vehicle structure; and
tightening the second strap relative to the first strap.

9. A method of securing a vehicle wiring harness, comprising:
positioning a fastener clip on a second strap integrally formed with a fastener head and concentrically positioned around a first strap integrally formed with the fastener head and spaced from the second strap, wherein the first strap is wrapped about a wiring harness along a length of the wiring harness and secured within the fastener head to fix the fastener head relative to the wiring harness.

10. The method of claim 9 further comprising:
sliding the fastener clip along the second strap to align with a wiring harness mounting point; and
securing the fastener clip to the wiring harness mounting point.

11. The method of claim 9 wherein the fastener head comprises:
a first opening and a first locking mechanism disposed within the first opening configured to unidirectionally secure the first strap within the first opening; and
a second opening and a second locking mechanism disposed within the second opening configured to unidirectionally secure the second strap within the second opening.

12. The method of claim 11 wherein the first and second straps are spaced at the fastener head to provide a clearance gap relative to one another to permit movement of the fastener clip along the second strap relative to the first strap.

13. The method of claim 9 further comprising:
securing the fastener clip in a complementary vehicle structure; and
connecting the second strap to the fastener head.

14. A vehicle wiring harness retainer assembly comprising:
a fastener head having
a first opening extending along a first axis,
a first locking mechanism disposed within the first opening,
a second opening extending along a second axis, and
a second locking mechanism disposed within the second opening;
a first strap extending away from the first opening in a first direction; and
a second strap extending away from the second opening in a second direction.

15. The vehicle wiring harness retainer of claim 14 wherein a portion of the first strap proximate the first opening is substantially parallel to the first axis and a portion of the second strap proximate the second opening is substantially parallel to the second axis.

16. The vehicle wiring harness retainer of claim 14 wherein the first strap has a first width and the second strap has a second width less than the first width.

17. The vehicle wiring harness of claim 14 further comprising a fastener clip having a first portion slidably engaged with the second strap and a second portion configured to secure the fastener clip into a complementary vehicle structure.

18. The vehicle wiring harness of claim 14 wherein the first direction is different than the second direction.

19. The vehicle wiring harness of claim 14 wherein the first strap is positioned around a wiring harness and secured within the first opening and the second strap is wrapped around the first strap and secured within the second opening.

20. The vehicle wiring harness of claim 14 wherein the second strap is generally concentrically positionable relative to the first strap securedly engaged with a vehicle wiring harness.
